(19) United States
(12) Patent Application Publication
(10) Pub. No.: US 2004/0147320 A1
(43) Pub. Date: Jul. 29, 2004

(54) Gaming or slot machine arrangement

(76) Inventors: Ulrich Schmidt, Stemwede (DE); Reinhold Lüders, Espelkamp (DE)

Correspondence Address: GUDRUN E. HUCKETT DRAUDT, LONSSTR. 53, WUPPERTAL, 42289, DE

(21) Appl. No.: 10/472,941

(22) PCT Filed: Sep. 13, 2001
(86) PCT No.: PCT/EP01/10555

(30) Foreign Application Priority Data
Mar. 30, 2001 (DE) 101 16 086.0

(51) Int. Cl. A63F 13/00

(52) U.S. Cl. 463/42

(57) ABSTRACT

A machine arrangement has usage charge incurring gaming or vending machines, a remote central data processing device, and a usage charge incurring data line connecting the gaming or vending machines to the central data processing device. When operating the gaming or vending machine, management-relevant and safety-relevant data are transmitted via the data line to the central data processing device. At least one motivation machine is arranged at the site of the gaming or vending machine and is connected by a clearing device to the gaming or vending machine such that data flow from the central data processing device to the motivation machine is hooked up to the data line when the data line is activated by operation of the gaming or vending machine for transmitting the management-relevant or safety-relevant data and the motivation machine receives cost-free motivation games, information, advertisement, and Internet service from the central data processing device.

The invention relates to a machine arrangement comprising at least one usage charge incurring gaming or slot machine that is operated in a suitable room, for example, a gaming hall, a restaurant or the like, and is connected by means of a usage charge incurring data line to a remote central data processing device. During operation of the gaming or vending machine, this serves for transmitting management-relevant and safety-relevant data to the central data processing device for evaluation, monitoring, and remote adjustment so that from here control and monitoring of the gaming and vending machines can be carried out. Here, information with regard to the frequency of use of the device, the sales, or filling level within a vending machine, the proper function of the devices etc. is collected, evaluated and made available again to the operators of the devices, respectively.

Such machine arrangements are used frequently in practice. All of these arrangements have in common that they can be operated only by paying usage fees. If an operator of the machines desires to enable clients in the gaming hall or in the restaurant to use the machines free of charge, he himself must pay the operating costs which, in turn, makes such a project economically unattractive.

It is therefore an object of the invention to solve this problem and to provide a machine arrangement that fulfills simultaneously the needs of the gaming hall or restaurant operators as well as those of the clients.

This object is solved by a machine arrangement having the features of claim 1.

In this connection, at the site of the gaming or vending machine, i.e., in the gaming hall, the restaurant, or the like, at least one motivation machine is installed via which cost-free motivation games, information, advertisement, Internet or the like can be received from the central data processing device and made available to the client at no cost. In order to be able to provide this no-cost service to the client, the motivation machine is connected by means of a clearing device such with the gaming or vending machine that a data flow from the central data processing device to the motivation machine can be hooked up to a data line when it is already activated by operation of the gaming or vending machines for the purpose of transmitting their management-relevant or safety-relevant data, for example, financial data of the machines, or the corresponding manipulation protection data, to the central data processing device. The data transmitted to the motivation machine concerning the motivation game, diverse information, advertisement, Internet connection or the like are then essentially saddled in a piggyback method onto the management-relevant or safety-relevant data of the gaming or vending machines and are thus transported also by means of the already activated line.

The usage charge data line between the vending or gaming machine is generally a fee-incurring telephone line so that the machine arrangement can be operated at any location where a telephone connection is available. The cost-free data transmission to the motivation machine however always requires that at the same time a usage cost incurring data flow is under way from a gaming or vending machine.

An example for motivation games to be operated on the motivation machine is a lotto game where the user in temporal intervals (for example, maximally every ten minutes) can place a gambling bet in the form of, for example, a number combination, regarding advertised prize money. The prize money can be financed preferably by the advertisement that is imported between the betting opportunities.

Several of the described machine arrangements, installed at different sites, can be combined with one another via the central data processing machine so that it is possible to centrally control, for example, a larger enterprise having several gambling halls that are operated simultaneously. In this connection, it is possible to run, for example, lotto games at the same time at different motivation machines in the different gambling halls, wherein, for increasing the thrill, on the monitor of the motivation machine it can be displayed, for example, which one of the motivation machines in which one of the gaming halls has received a lotto bet currently coming closest to the winning combination.

Technically, the clearing device can be realized in a most simple way in a separate node computer at the location of the gaming or vending machine and of the motivation machine, wherein the node computer, in turn, provides the connection to the central data processing device. In this way, an internal networking of the gaming, vending, and motivation machines of a gaming hall is realized, wherein, in turn, the external network of several gaming halls is realized via the central data processing device.

Preferably, the motivation machine has an identification device which enables identification of the current user of the motivation device. This enables, for example, to allocate predetermined maximum gaming intervals to a user, to obtain general data in regard to frequenting of the device, and, of course, also to identify the winner of possibly performed lotto games or the like. Preferably, the identification device can be realized in the form of a chip card reader, a magnetic strip card reader or a transponder, wherein frequent users of the motivation machine can, for example, request a club card that eliminates the requirement of having to enter name, address and the like for each use.

When an identification device is provided, it is also possible to combine it with a time interval circuit that terminates or interrupts the use of the motivation machine by an individual person after a certain time interval. In this way, it is prevented that the cost-free motivation machine is blocked over an extended period of time by a single person.

In order to be able to import constantly changing and current information to the motivation machine, it is advantageous to provide an external connection on the central data processing unit, in particular, an Internet connection, via which data, games, programs, advertisement and other information to be newly transmitted can be imported.

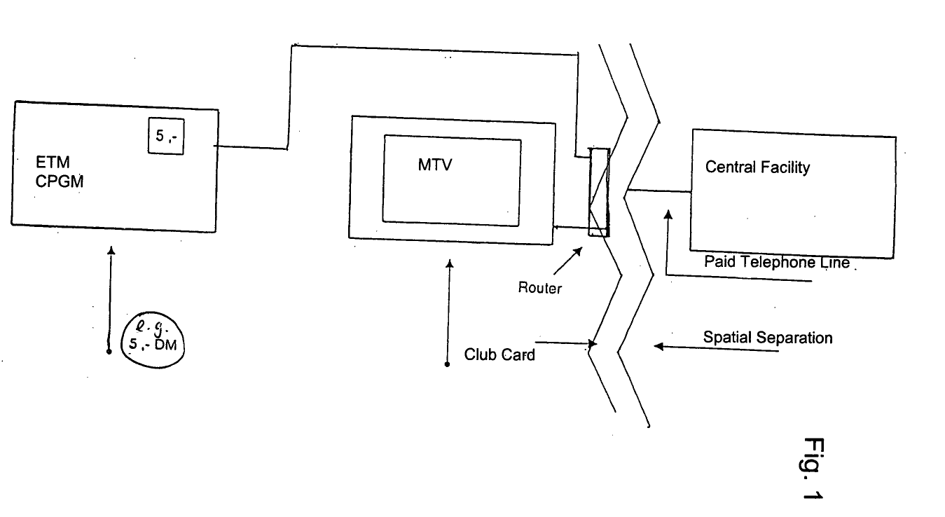

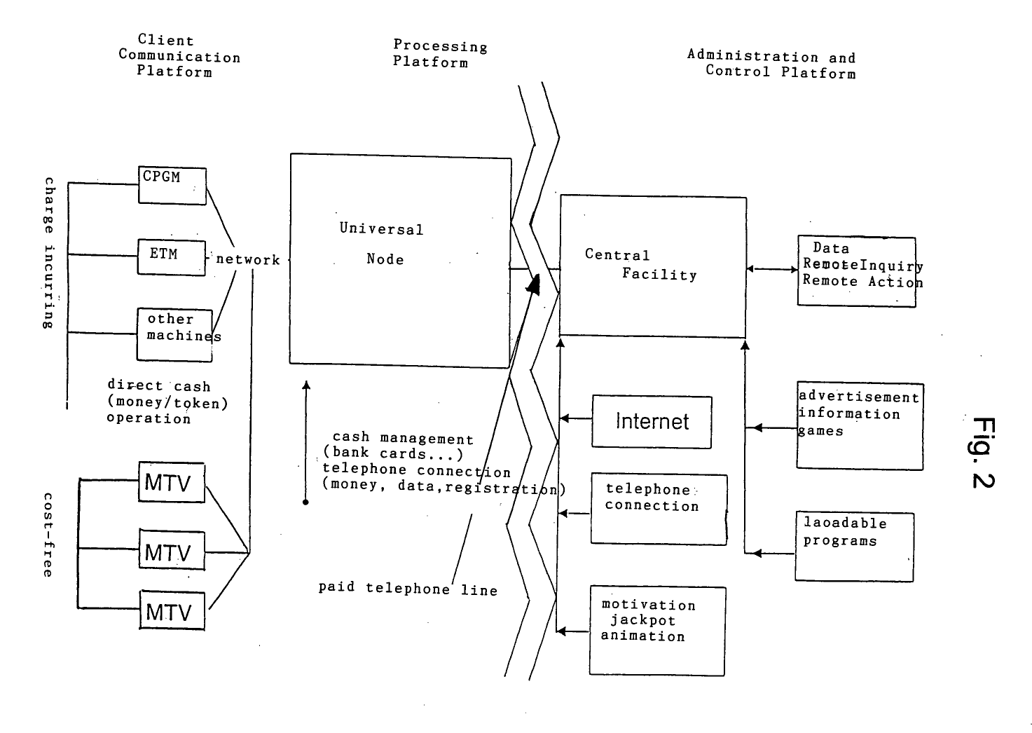

In FIGS. 1 and 2, the machine arrangements according to the invention are schematically illustrated. FIG. 1 shows in this connection a simple machine arrangement with only a single gaming or vending machine and a motivation machine. In FIG. 2, a more complex arrangement having several gaming and vending machines as well as motivation machines is illustrated.

The following abbreviations represent the following terms.

ETM=entertainment machine

CPGM=cash payout gaming machine

MTV=motivation machine

CDPD=central data processing device

FIG. 2 illustrates clearly the client communication platform with the gaming, vending, and motivation machines; the processing platform with the universal node computer; and the administration and control platform with the central data processing device, wherein the central data processing device, as illustrated, is supplied from different sources.

The arrangement of machines according to the invention enables an excellent bonding of regular clients to the gaming hall or restaurant in that the users can carry out interactions at the motivation machines, even when pausing their games at the cash payout gaming machines or their use of vending machines, and information or games are offered thereat.

Of course, it is possible that a motivation machine can combine therein the function of a gaming machine so that the use of a motivation machine as a gaming machine, i.e., requiring a usage charge, is possible even when no other gaming or vending machine is in operation.

1. A machine arrangement comprising at least one usage charge incurring gaming or vending machine, connected to a remote central data processing device by means of a usage charge incurring data line, via which, during operation of the gaming or vending machine, management-relevant and safety-relevant data are transmitted to the central data processing device for evaluation, monitoring, and remote adjustment, characterized in that at the site of the gaming or vending machine at least one motivation machine, via which cost-free motivation games, information, advertisement, Internet or the like can be received from the central data processing device, is connected by means of a clearing device to the gaming or vending machine such that a data flow from the central data processing device to the motivation machine can be always hooked up to the data line when the latter is activated by operation of the gaming or vending machine for transmitting its management-relevant or safety-relevant data to the central data processing device.

2. The machine arrangement according to claim 1, characterized in that the clearing device is arranged in a separate node computer at the site of the gaming or vending machine and of the motivation machine, which node computer connects the gaming or vending machine(s) and motivation machine(s) and the central data processing device with one another.

3. The machine arrangement according to claim 2, characterized in that several locally neighboring gaming, vending, and/or motivation machines are networked with one another via the node computer.

4. The machine arrangement according to one of the claims 1 to 3, characterized in that the motivation machine has an identification device enabling identification of a user of the motivation machine, respectively.

5. The machine arrangement according to claim 4, characterized in that the identification device is a chip card reader, a magnetic strip card reader, or a transponder.

6. The machine arrangement according to claim 4 or 5, characterized in that the motivation device is provided with a time interval circuit that terminates or interrupts after a certain time interval an authorization of use of the motivation machine for a person identified by the identification device.

7. The machine arrangement according to one of the claims 1 to 6, characterized in that the central data processing device has an external connection, in particular, Internet connection, for importing data, such as games, programs, advertisement or the like to be transmitted to the motivation device.

8. A plurality of machine arrangements, characterized by combining several machine arrangements according to one of the claims 1 to 7 with remote gaming and/or vending and motivation machine groups via a central data processing device.
